(19) United States
(12) Patent Application Publication
(10) Pub. No.: US 2012/0236695 A1
(43) Pub. Date: Sep. 20, 2012

(54) OPTICAL DISK DEVICE AND DRIVING METHOD THEREOF

(75) Inventor: Tomomi OKAMOTO, Yokohama (JP)

(73) Assignees: Hitachi Consumer Electronics Co., Ltd.; Hitachi-LG Data Storage, Inc.

(21) Appl. No.: 13/418,388

(22) Filed: Mar. 13, 2012

(30) Foreign Application Priority Data
Mar. 18, 2011 (JP) 2011-060032

(51) Int. Cl. G11B 7/1392; G11B 7/0037

(52) U.S. Cl. 369/44.23; 369/44.32; G9B/7.128; G9B/7.005

(57) ABSTRACT

The optical disk device can stably control an aberration correction lens even when one end of a movable range of the aberration correction lens is set as a reference position. The optical disk device comprises an optical pickup unit including the aberration correction lens and a stepping motor for moving the aberration correction lens, wherein, when an optical disk is inserted into the optical disk device, the aberration correction lens is moved to the reference position within the movable range and near one end thereof, and wherein, when moving the aberration correction lens to the reference position, driving pulses are applied to the stepping motor to press the aberration correction lens against the one end of the movable range, and thereafter a predetermined number of pulses are applied to reversely rotate the stepping motor and to set a stop position where the aberration correction lens stops as the reference position.

### INCORPORATION BY REFERENCE

The present application claims priority from Japanese application JP2011-060032 filed on Mar. 18, 2011, the content of which is hereby incorporated by reference into this application.

### BACKGROUND OF THE INVENTION

The present invention relates to an optical disk device recording or reproducing on or from an optical disk and a driving method thereof.

As a method of recording or reproducing on or from an optical disk, Blu-ray Disc has been developed recently. In the Blu-ray Disc, an objective lens with the aperture ratio of 0.85 is used, and thereby an optical spot is focused onto a narrow track on the optical disk to perform high-density recording. On the other hand, where an objective lens with a high aperture ratio is used, the considerable influence from the spherical aberration caused by a thickness error of a protective layer of the optical disk requires a correcting means to correct the spherical aberration.

For example, a correcting means to correct the spherical aberration and an adjusting method to adjust the spherical aberration are described in JP-A-2006-318590. In JP-A-2006-318590, the aberration correcting means uses a beam expander to adjust the aperture and the aberration adjusting method controls the aberration correcting means to make the reflected light obtained from an optical disk have the adequate signal quality.

Here, the aperture adjustment using the beam expander is realized by moving an aperture adjusting lens by means of a stepping motor. Since the stepping motor can control the rotation angle according to the number of pulses applied thereto, it can control the position of the lens by converting the rotational motion to a linear motion by means of a lead screw provided on a rotating shaft. In this method, once the reference position of the lens is detected, the position of the aperture adjusting lens can be controlled just by managing the number of pulses. Note that, as JP-A-2007-129811 describes, the movement mechanism using a stepping motor is also employed as, for example, a moving means to move an optical pickup unit.

In addition, JP-A-2005-190630 describes as a problem “This invention tries providing an optical disk drive capable of precisely positioning an optical pickup at a desired starting radial-position without depending on the dimension accuracy of a stopper, and a method of determining the starting position of the optical pickup”; and describes “Upon completion of loading of a reference disk by a load/unload mechanism 19, a signal indicative of the completion of loading is sent from the load/unload mechanism 19 to a system controller 1. Then, upon receipt of this signal, the system controller 1 moves, according to the above learning program, an optical pickup 4 to the inner peripheral side of an optical disk D until it touches a stopper 20 by driving a feed mechanism 5 including a feed motor (Steps 202 and 203). Thereafter, the system controller 1 moves the optical pickup 4 from the position where it touches the stopper 20 to the outer peripheral side of the optical-disk D by driving the feed mechanism 5 including the feed motor by a specified feed-control amount (Step 204).” (see paragraphs 0007, 0030, 0031, etc.).

### SUMMARY OF THE INVENTION

There is a method to move an aberration correction lens to one end in a moving range of the aberration correction lens to determine the above reference position. This method, as shown in FIG. 7, applies a necessary and sufficient number of pulses to a stepping motor to press the aberration correction lens against one end of the movable range and place the absolute position of the aberration correction lens at the one end of the movable range, and sets this position as the reference position. If pulses are applied to the stepping motor, the aberration correction lens will move in the direction of the one end of the movable range, but the position of the aberration correction lens pressed against the one end of the movable range will not change even if additional pulses are applied. The necessary and sufficient number of pulses may be applied, until for example, the number of pulses exceeds the number necessary for the movement over a movable range of the aberration correction lens or until the stoppage of the stepping motor is detected by a change in the measured back-electromotive current of the stepping motor. In the case of the method of setting the one end of the movable range as the reference position, a reduction in cost can be achieved because it is unnecessary to prepare a position sensor for detecting the lens position.

By the way, the movement mechanism using a stepping motor has a problem of step-out or losing steps as shown in JP-A-2007-129811. The stepping motor can control the rotation angle according to the number of applied pulses, but when step-out occurs, a rotator of the stepping motor will transition to the next magnetic stable point and thus the number of applied pulses will not correspond to the actual rotation angle. For example, if step-out occurs in the stepping motor driven in two-phase excitation mode, the actual rotation angle will get out of step with the number of pulses in units of four pulses. It is difficult to accept such out-of-step in the aberration correction mechanism controlling the position of the lens according to the number of pulses.

In the case of the method of setting the one end of the movable range of the aberration correction lens as the reference position, the aberration correction lens always needs to be pressed against the one end of the movable range. However, pressing the aberration correction lens against the one end of the movable range causes errors between applied pulses and a rotator position of the stepping motor. This is described in reference with FIG. 8. FIG. 8 shows the applied pulse of each phase input to stepping motor terminals, a relationship between the pulses applied to the stepping motor and the position of the aberration correction lens, the pulses applied to the stepping motor, and the errors between the applied pulses and the rotator position. Here, if the stepping motor is driven in two-phase excitation mode inputting an A phase and a B phase which are different by 90 degrees from each other, a change in either of the A phase and the B phase results in applying a pulse to the stepping motor. By applying pulses to the stepping motor, the aberration correction lens moves to the one end of the movable range, and at the one end of the movable range, the aberration correction lens cannot move even if pulses are applied. In this case, any errors will not occur between the applied pulses and the rotator position in motion because the aberration correction lens is moving in response to pulses. Although pulses are applied after the aberration correction lens becomes immovable at the one end of the movable range, the rotator remains at rest and thus errors occur between the pulses and the rotator position. In the case of two-phase excitation, the errors periodically occur for every four pulses. The errors cannot be detected in advance because it depends on the position of the aberration correction lens before it starts moving when the aberration correction lens hits against the one end of the movable range. Therefore, the errors may result in +2 pulses to −1 pulse.

Where the next drive starts with errors between the applied pulses and the rotator position, the applied pulses do not match the rotator position for the first several pulses, resulting in an unstable rotation or step-out. Accordingly, where the one end of the movable range is set as the reference position, it is necessary to perform the protecting process against step-out.

JP-A-2005-190630 discloses a technique for reducing the influence of a mechanical size error of a stopper when positioning the radial position of an optical pickup on an optical disk, but does not disclose the positioning control of a spherical aberration correction mechanism. In JP-A-2005-190630, the applied pulse does not match the rotator position as described above, and the problem of step-out is not considered.

The objective of the present invention is to provide an optical disk device capable of stably controlling an aberration correction lens even where one end of the movable range is set as the reference position of the aberration correction lens.

The above problem can be improved by the inventions described in the claims, for example.

The present invention can provide an optical disk device capable of stably controlling an aberration correction lens even where one end of the movable range is set as the reference position of the aberration correction lens.

Other objects, features and advantages of the invention will become apparent from the following description of the embodiments of the invention taken in conjunction with the accompanying drawings.

### BRIEF DESCRIPTION OF THE DRAWINGS

FIG. 1 is a configuration diagram of an optical disk device according to an embodiment.

FIG. 2 illustrates the configuration of a spherical aberration correction adjustment mechanism, the movable range of an aberration correction lens, and the position of the correction lens for correcting the aberration according to the embodiment.

FIG. 3 illustrates the operation to move the aberration correction lens to one end of the range and detect a reference position according to the embodiment.

FIG. 4 shows the position of the aberration correction lens with respect to input pulses of respective phases input to the stepping motor terminals, and errors between the applied pulses and the rotator position according to the embodiment.

FIG. 5 shows the movement of the aberration correction lens when one pulse is applied to the stepping motor.

FIG. 6 shows a process flow during disk loading according to the embodiment.

FIG. 7 shows a relationship between the number of pulses and the position of the aberration correction lens when moving the aberration correction lens to the one end of the movable range.

FIG. 8 shows the position of the aberration correction lens with respect to input pulses of respective phases input to the stepping motor terminals, and errors between the applied pulse and the rotator position.

### DETAILED DESCRIPTION OF THE EMBODIMENTS

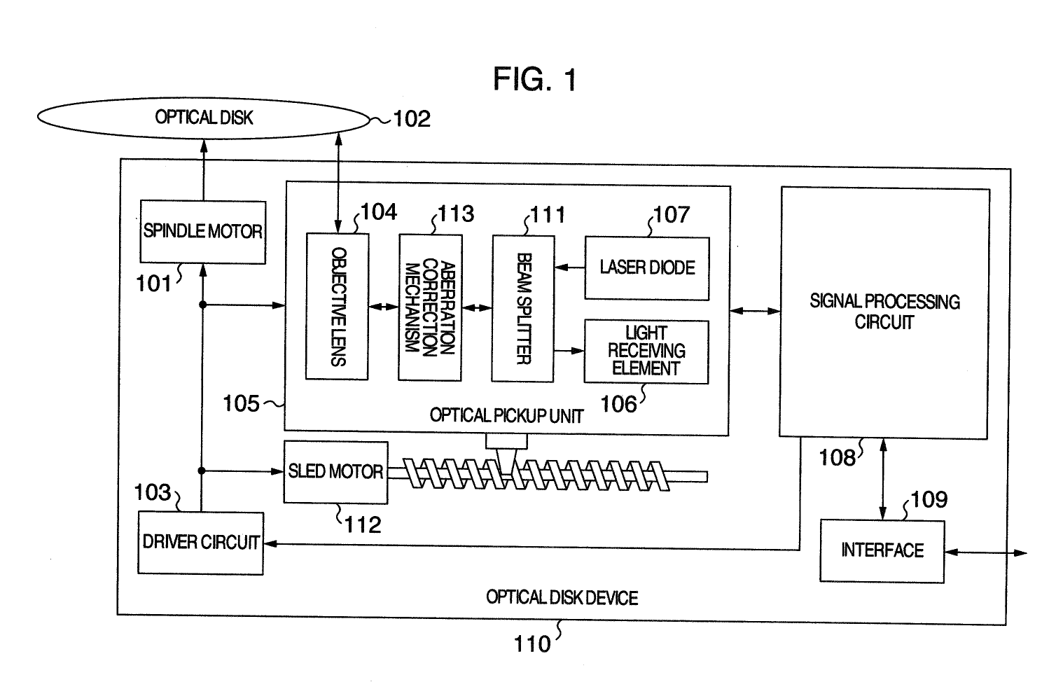

The embodiment will be described below using FIGS. 1 to 6. FIG. 1 shows the configuration of an optical disk device according to the embodiment. An optical disk 102 is rotated by a spindle motor 101 and a driver circuit 103. Light emitted from a laser diode 107 mounted on an optical pickup unit 105 travels through a beam splitter 111 and an aberration correction mechanism 113, and is focused onto a data recording surface on the optical disk 102 by means of an objective lens 104. Then, the light focused onto the optical disk 102 is reflected by the data recording surface; and the reflected light travels again through the objective lens 104, the aberration correction mechanism 113, and the beam splitter 111, and thereafter enters a light receiving element 106 which converts it to an electric signal. The electric signal output from the light receiving element 106 is input to a signal processing circuit 108. The signal processing circuit 108 processes the input signal and communicates with an externally-connected device through an interface 109, or feeds back the processed signal to the driver circuit 103 to control the spindle motor 101, the optical pickup unit 105, and a sled motor 112. The signal processing circuit 108 also controls the aberration correction mechanism 113.

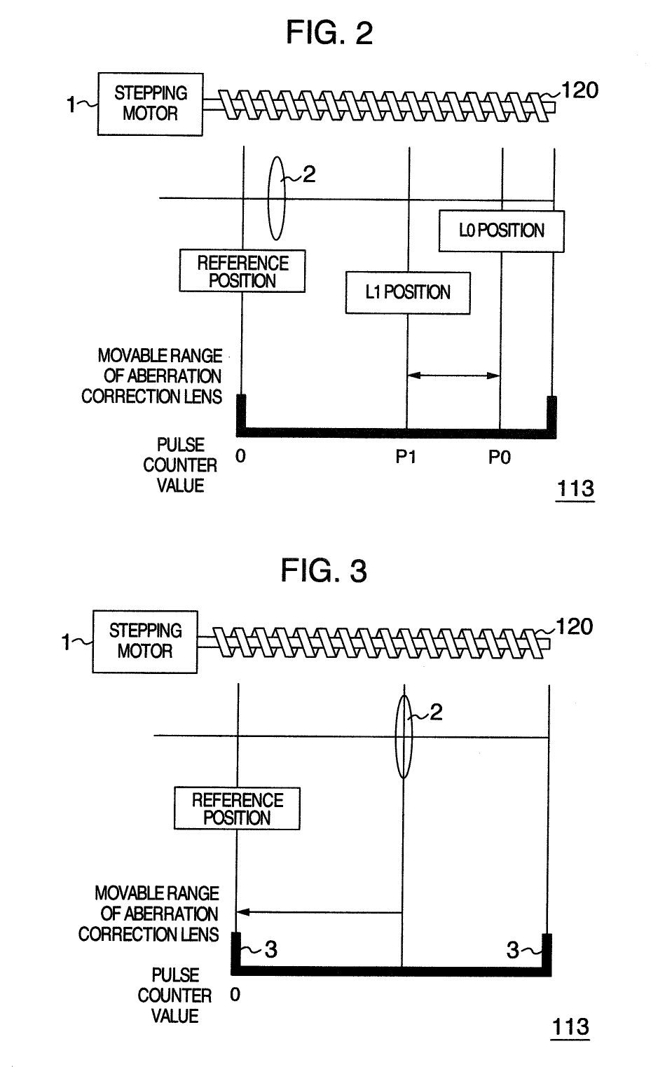

Next, the configuration and arrangement of the aberration correction mechanism 113 are described using FIG. 2. The aberration correction mechanism 113 shown in FIG. 2 comprises an aberration correction lens 2 and a stepping motor 1. A spirally grooved lead screw 120 is added to the stepping motor 1. The lead screw 120 converts the rotation of the stepping motor 1 to a linear motion, and moves the aberration correction lens 2. Moreover, the reference position of the stepping motor is based on one end of the movable range of the aberration correction lens. If the optical disk has a two-surface structure (hereinafter, the respective recording surfaces are referred to as an L0 surface and an L1 surface) and the appropriate position of the aberration correction lens 2 are located at an L0 position and an L1 position with respect to respective recording surfaces, then the aberration correction lens 2 is positioned to the L0 position or the L1 position by managing the number of pulses applied to the stepping motor 1 during moving from the reference position to the L0 position or the L1 position.

Moreover, after positioning the aberration correction lens 2 to the reference position the optical disk device 110 counts the number of pulses applied to the stepping motor 1 by means of the signal processing circuit 108. A pulse counter therefor may be realized by software or may be realized by hardware. In the pulse counter, for example, when applying pulses to move the aberration correction lens 2 from the reference position to the L0 position, the applies pulses are counted up, while, when applying pulses to the aberration correction lens 2 to move it in the opposite direction, the applied pulses are counted down. It is needless to say that, on the contrary, when applying pulses to move the aberration correction lens 2 from the reference position to the L0 position, the pulse counter may be configured to count down the applied pulses. After setting the pulse count at the reference position to zero which is the initial value, the signal processing circuit 108 stores pulse counter value P0 or P1 corresponding to the appropriate L0 position or L1 position at which the aberration is corrected and adjusted in each recording surface of the disk, and then the signal processing circuit 108 applies pulses to the stepping motor 1 until the pulse counter value becomes P0 or P1 to perform the position control of the aberration correction lens 2. In this method, the position control can be performed by pulse control.

Next, a method to move the reference position of the aberration correction mechanism is described with reference to FIG. 3. In the present invention, a position within a movable range of the aberration correction lens and near one end thereof is set as the reference position of the aberration correction lens. The insertion of an optical disk into the optical disk device causes the movement of the reference position to be performed. The following examples will be described as a method to position the aberration correction lens to the one end of the movable range.

The aberration correction lens has a movable range in which it can physically move. When setting to N the number of pulses applied to the stepping motor to move the aberration correction lens from one end 3 of this movable range to the other end 3 thereof, the aberration correction lens is pressed against the one end of the movable range by applying only N pulses to the stepping motor. In this method, even if the aberration correction lens is located at any position within the movable range, the aberration correction lens can move to the one end of the movable range.

In addition, another example will be described as a method to move the aberration correction lens to the one end of the movable range. A measuring means to measure the back-electromotive current generated when a stepping motor rotates is mounted on the optical disk device. Because the stepping motor is rotating while the aberration correction lens is moving in the direction of the one end of the movable range, the back-electromotive current is generated. However, once the aberration correction lens has moved to the one end of the movable range, it cannot move any more and thus the stepping motor stops rotating and the back-electromotive current is not be generated. By this change in the back-electromotive current, the measuring means detects that the aberration correction lens has moved to the one end of the movable range, and stops applying pulses. Note that, as the method of detecting the back-electromotive current, it is considered to turn off drive signals and detect a current during a short time compared to a pulse interval of the drive signals which the driver circuit 103 applies to the stepping motor shown in FIG. 1.

Next, the aberration correction lens having come to the one end of the movable range moves in the opposite direction during applying a predetermined number of pulses and then stops. This method can dissolve errors between the applied pulses and the rotator position of the stepping motor, the errors being caused by pressing the aberration correction lens against the one end of the movable range.

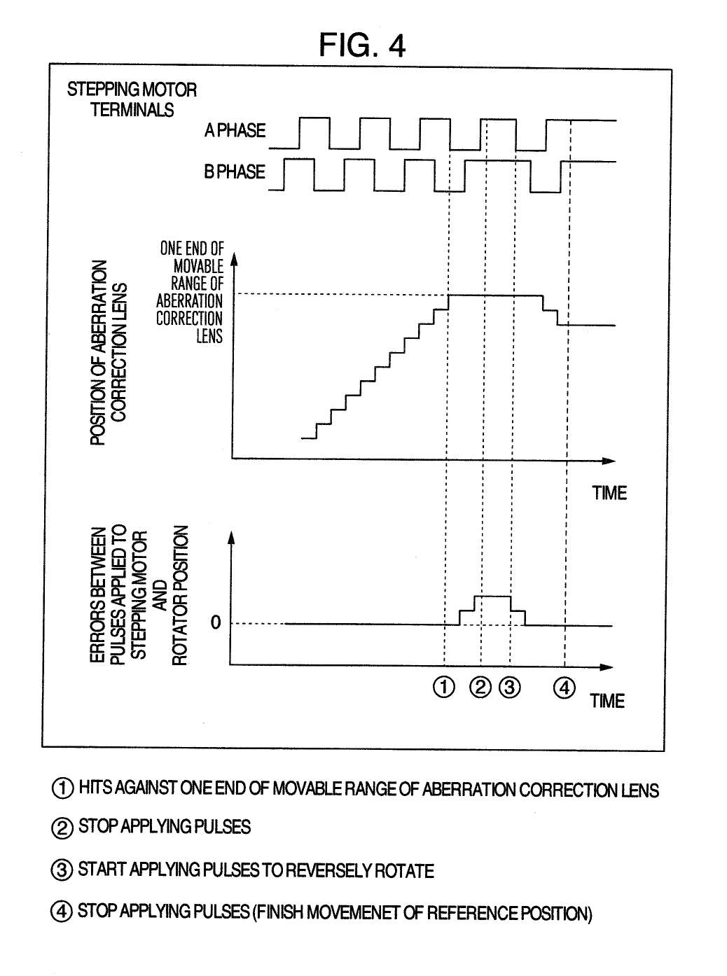

As shown in FIG. 4, (1) the aberration correction lens moved to the one end of the movable range hits against the one end of the movable range; and (2) the aberration correction lens stops after further applying several pulses. In this state, errors have already occurred between the rotator position of the stepping motor and the pulses. (3) Next, reversely rotating the stepping motor for a specified number of rotations makes clearance of the relation between the one end of the movable range and the aberration correction lens and thus the errors are dissolved. (4) Then, this position is set as the reference position of the aberration correction lens, and the movement of the aberration correction lens is finished.

Note that, where the stepping motor is driven in two-phase excitation mode, four pulses are suitable as the above number of pulses applied to move the aberration correction lens in the opposite direction. This is because a signal applied to stepping motor terminals in two-phase excitation is repeated in units of four pulses, and thus if the aberration correction lens moves in the opposite direction by applying only four pulses at most, the pulses that match the rotator position are output.

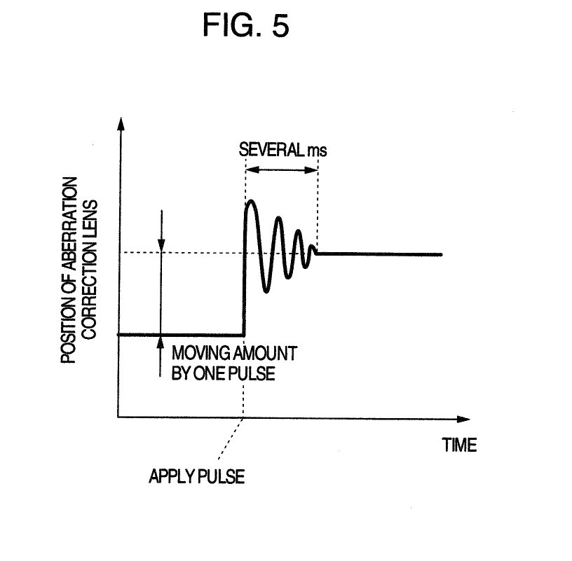

Although the aberration correction lens stops after moving in the opposite direction, a stop time equal to or greater than 10 ms may be provided before it starts moving from this stop position next time. FIG. 5 shows a movement of the aberration correction lens when one pulse is applied to the stepping motor. After applying the pulse, the aberration correction lens will settle with damping vibration near a target position. The time until the aberration correction lens settles is on the order of several ms in the case where a stepping motor has such a size that it can be mounted on the optical pickup. By providing the stop time before the next movement after the reverse rotation, the aberration correction lens can settle and the errors between the applied pulses and the rotator position can be reliably dissolved. Accordingly, it is effective to provide the stop time of about 10 ms, taking into consideration the settling time of the stepping motor.

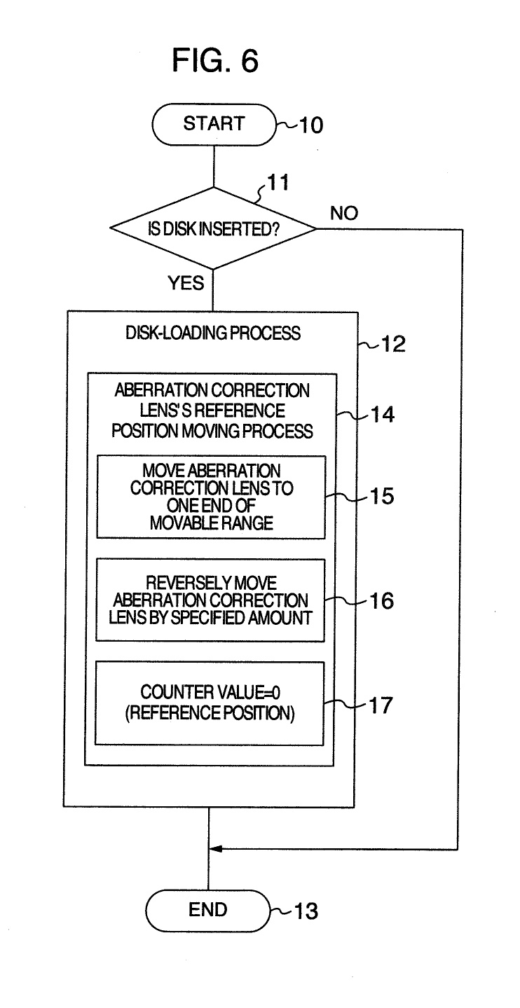

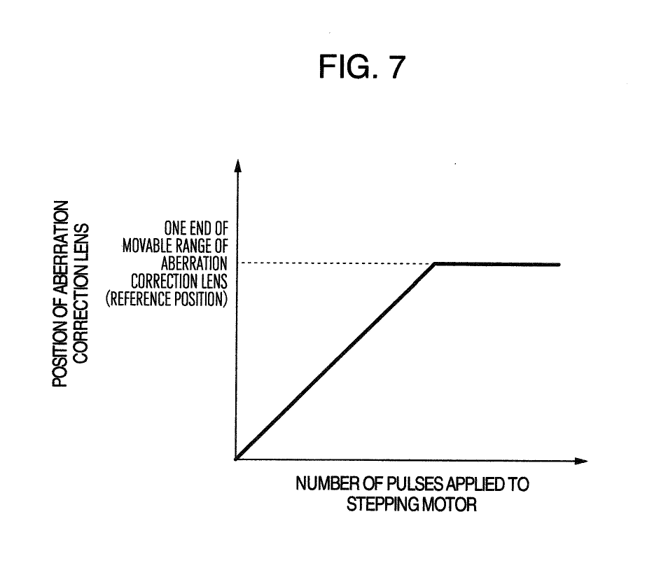

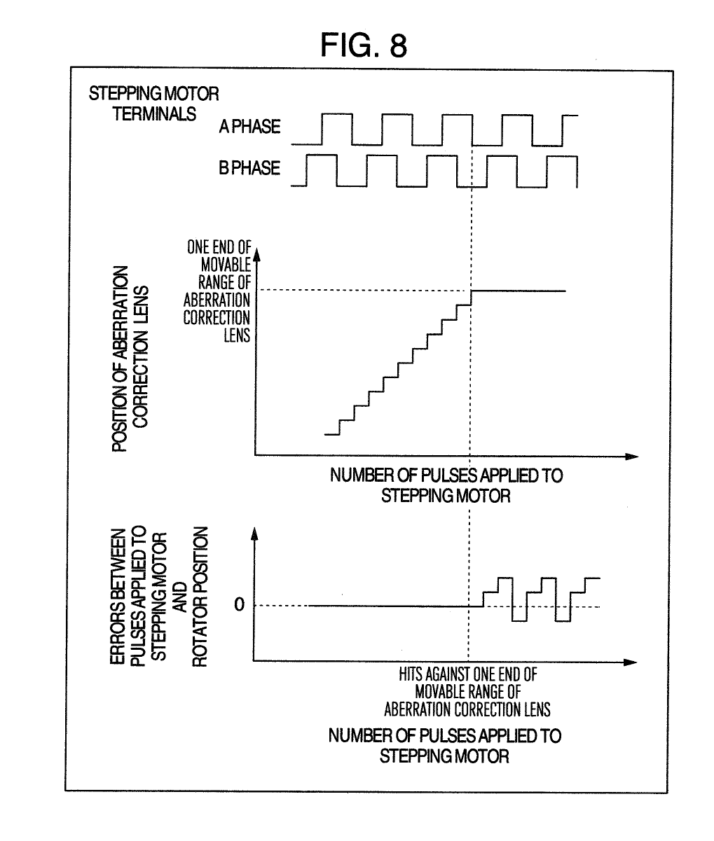

FIG. 6 shows a movement flow of an aberration correction lens's reference position according to the embodiment. The insertion of a disk into the optical disk device causes this movement to be performed. When an optical disk is inserted into the optical disk device (11), a disk-loading process (12) starts. As a part of this disk-loading process (12), an aberration correction lens's reference position moving process (14) is performed. In the aberration correction lens's reference position moving process (14), first the aberration correction lens is pressed against the one end of the movable range (15), and then the aberration correction lens is reversely moved a specified amount from the one end of the movable range (16) and a counter value is reset (17) which controls the position of the aberration correction lens in the optical disk device. Thereafter, the position control of the aberration correction lens is performed by managing the number of pulses applied to the stepping motor, the pulses being added or subtracted to or from the counter.

Note that, in the embodiment, the insertion of an optical disk into the optical disk device causes the movement of the reference position to be performed, but not limited thereto. For example, the ejection of an optical disk may causes the movement of the reference position to be performed so as to reduce the time necessary for the disk-loading process when an optical disk is inserted next time. Alternatively, the power-on of the optical disk device may causes the movement of the reference position to be performed, and, while the optical device is powered on, the position of the aberration correction lens may be controlled by managing the number of pulses.

In addition, a part or all of each component described above may be configured by hardware, or may be configure so as to be realized by a processor executing a program. Further, control lines or information lines that are considered necessary for explanation are shown, but all the control lines or information lines necessary for products are not necessarily shown. Actually, it may be considered that almost all components may be connected to each other.

It should be further understood by those skilled in the art that although the foregoing description has been made on embodiments of the invention, the invention is not limited thereto and various changes and modifications may be made without departing from the spirit of the invention and the scope of the appended claims.

1. An optical disk device for recording or reproducing user data on or from an optical disk, wherein
the optical disk device
comprises an optical pickup unit including an aberration correction lens and a stepping motor for moving the aberration correction lens, and
performs a reference position moving process for moving the aberration correction lens to a reference position, a position within a movable range of the aberration correction lens and near one end thereof being set as the reference position, wherein
the reference position moving process applies driving pulses to the stepping motor to press the aberration correction lens against the one end of the movable range, and thereafter applies a predetermined number of pulses to reversely rotate the stepping motor and set a stop position where the aberration correction lens stops as the reference position.

2. The optical disk device according to claim 1, wherein the insertion of the optical disk into the optical disk device causes the reference position moving process to be performed.

3. The optical disk device according to claim 1, wherein the ejection of the optical disk from the optical disk device causes the reference position moving process to be performed.

4. The optical disk device according to claim 1, wherein the power-on of the optical disk device causes the reference position moving process to be performed.

5. The optical disk device according to claim 1, wherein the stepping motor is driven in two-phase excitation mode and the number of pulses for reversely rotating the stepping motor is set to four.

6. The optical disk device according to claim 1, wherein a stop time is equal to or greater than 10 ms.

7. The optical disk device according to claim 1, wherein, if the number of pulses applied to the stepping motor necessary to move from one end of the movable range of the aberration correction lens to the other end of the movable range is set to N, the aberration correction lens is pressed against the one end of the movable range, by applying N pulses to move in the direction of the one end of the movable range to be set as the reference position.

8. The optical disk device according to claim 1, further comprising a measuring means to measure a back-electromotive current which the stepping motor generates while pulses are applied thereto, wherein
the measuring means measures the back-electromotive current generated while the aberration correction lens is moving in the direction of the one of the movable range, and detects by a change in the back-electromotive current that the aberration correction lens is pressed against the one end of the movable range.

9. A method for driving an optical disk device comprising an optical pickup unit, the optical disk device recording or reproducing user data on or from an optical disk, wherein
the method
has a function to linearly move a movable part by means of a stepping motor mounted on the optical disk device, and
comprises
a first step for moving the movable part and pressing the same against one end of a movable range of the movable part, and
a second step for moving the movable part a specified amount away from the one end of the movable range.

10. The method according to claim 9, wherein the stepping motor is driven in two-phase excitation mode, and the specified amount in the second step is a moving amount obtained by applying four pulses to the stepping motor.

11. The method according to claim 9, wherein a stop time equal to or greater than 10 ms is provided, the stop time being a time until the movable part moves next time after the movement in the second step.

12. The method according to claim 9, wherein the movable part is an aberration correction lens for correcting spherical aberration.
